(19) United States
(12) Patent Application Publication
(10) Pub. No.: US 2023/0234246 A1
(43) Pub. Date: Jul. 27, 2023

(54) END EFFECTOR ADAPTOR DEVICE FOR A ROBOTIC ARM

(71) Applicant: KINOVA INC., Boisbriand (CA)

(72) Inventors: Mathiew MOINEAU-DIONNE, Mirabel (CA); Yoan PICHÉ, Boisbriand (CA)

(21) Appl. No.: 18/154,915

(22) Filed: Jan. 16, 2023

Related U.S. Application Data
(60) Provisional application No. 63/301,718, filed on Jan. 21, 2022.

(51) Int. Cl. B25J 19/00; B25J 15/00; B25J 13/08; B25J 9/16; B25J 15/04

(52) U.S. Cl. CPC B25J 19/0033; B25J 15/0061; B25J 13/085; B25J 9/1697; B25J 15/045

(57) ABSTRACT

An end effector adaptor device for a robotic arm may have a body adapted to be secured to a working end of a robotic arm at a proximal face, the body having a distal face configured for connection of an end effector thereto. A proximal connector is in the proximal face, the proximal connector configured to be connected to a complementary connector at the working end of the robotic arm for signal and power transmission between the robotic arm and the body. A distal connector is in the distal face, the distal connector configured to be connected to a complementary connector at the end effector connected to the distal face for signal transmission and/or power transmission between the body and the end effector. Circuitry is between the proximal connector and the distal connector.

### CROSS-REFERENCE TO RELATED APPLICATION

The present application claims the priority of U.S. Patent Application No. 63/301,718, filed on Jan. 21, 2022 and incorporated herein by reference.

### TECHNICAL FIELD

The present application relates to robotic arms and to end effectors at the end of robotic arms.

### BACKGROUND OF THE ART

Robotic arms are increasingly used in a number of different applications, from manufacturing, to servicing, and assistive robotics, among numerous possibilities. Such robots can be used to perform given tasks, including repetitive tasks. The nature of the tasks may be related to the tools used as the ends of the robotic arms, which ends may be referred to as end effectors.

Because of the increased demand for robotic arms in a number of different uses, numerous tools have been devised to be used as robot end effectors. Such end effectors may be offered by a different party than the party offering the robotic arm. Accordingly, there may be a compatibility issue for users of robotic arms that want to use an end effector from a first party with a robotic arm of a second party. In the end, because of such compatibility problems, it may not be possible to use some end effectors with some robotic arms. Moreover, some robotic arms may not be configured to be used with multiple concurrent end effectors that may be complementary in nature, such as cameras and grippers.

### SUMMARY

It is an aim of the present disclosure to provide an adaptor for end effectors of robotic arms that addresses issues related to the prior art.

Therefore, in accordance with a first aspect of the present disclosure, there is provided an end effector adaptor device for a robotic arm comprising: a body adapted to be secured to a working end of a robotic arm at a proximal face, the body having a distal face configured for connection of an end effector thereto, a proximal connector in the proximal face, the proximal connector configured to be connected to a complementary connector at the working end of the robotic arm for signal and power transmission between the robotic arm and the body, a distal connector in the distal face, the distal connector configured to be connected to a complementary connector at the end effector connected to the distal face for signal transmission and/or power transmission between the body and the end effector, and circuitry between the proximal connector and the distal connector.

Still further in accordance with the aspect, for instance, The end effector adaptor device according to claim 1, further including another connector between the proximal face and the distal face, the other connector connected to the proximal connector by the circuitry so as to be configured for signal and power transmission to another peripheral.

Further in accordance with the aspect, for instance, the circuitry includes signal transmission circuitry configured to define a communication channel between the proximal connector, the distal connector and the other connector.

Still further in accordance with the aspect, for instance, the communication channel is an Ethernet communication channel.

Still further in accordance with the aspect, for instance, a vision module may be on the body, the vision module being connected to the proximal connector by the circuitry so as to be configured for signal and power transmission with the robotic arm.

Still further in accordance with the aspect, for instance, the body has a lateral extension projecting laterally between the proximal face and the distal face of the body.

Still further in accordance with the aspect, for instance, the vision module has at least one lens on a distal face of the lateral extension.

Still further in accordance with the aspect, for instance, the body has a lateral extension projecting laterally between the proximal face and the distal face, with a communication port on the lateral extension, the communication port connected to the circuitry.

Still further in accordance with the aspect, for instance, fasteners configured for releasably connecting the body to the robotic arm are provided.

Still further in accordance with the aspect, for instance, the fasteners are accessible on the distal face of the body.

Still further in accordance with the aspect, for instance, an alignment pin or bore in the proximal face of the body configured for engagement with a complementary component of the robotic arm.

Still further in accordance with the aspect, for instance, the body has two of the distal face, with each of the two distal faces configured to support an end effector.

Still further in accordance with the aspect, for instance, planes of the two distal faces of the adaptor device are angle relative to the proximal face.

Still further in accordance with the aspect, for instance, the body is tee-shaped or Y-shaped.

Still further in accordance with the aspect, for instance, the circuitry is a PCB embedded in the body.

Still further in accordance with the aspect, for instance, the PCB defines an EMI shield.

Still further in accordance with the aspect, for instance, the vision module includes a depth sensor.

Still further in accordance with the aspect, for instance, the body includes a force sensor and/or a torque sensor.

Still further in accordance with the aspect, for instance, the body a serial communication port or pogo pins.

Still further in accordance with the aspect, for instance, there is provided an assembly comprising: a robotic arm; and an end effector adaptor device as described above, the end effector adaptor device connected to an end of the robotic arm and configured to be connected to an end effector.

Still further in accordance with the aspect, for instance, there is provided a end effector adaptor device which adopts a modular approach while blocking EMI emissions or causing EMC issues.

Still further in accordance with the aspect, for instance, the end effector adaptor device uses a PCB as an EMI shield.

Still further in accordance with the aspect, for instance, the end effector adaptor device uses a metal shield as an EMI blocker while allowing connections through.

Still further in accordance with the aspect, for instance, the end effector adaptor device contains an integrated (no external wire) PoE or GigE Vision port.

Still further in accordance with the aspect, for instance, the end effector adaptor device contains an integrated Gigabit Ethernet port internally routed.

Still further in accordance with the aspect, for instance, the end effector adaptor device allows pass-through of electrical and communication signals between stackable, modular pucks.

Still further in accordance with the aspect, for instance, the end effector adaptor device defines a standard interface for robotic grippers or 3^{rd} party or OEM gripper interface.

### DESCRIPTION OF THE DRAWINGS

FIG. 1 is a perspective view of an exemplary articulated robotic arm that may be used with an end effector adaptor device of the present disclosure;

FIG. 2 is a perspective view of a wrist of the exemplary articulated robotic arm of FIG. 1, showing an interface;

FIG. 3 is another perspective view of the wrist of FIG. 2, illustrating connectors;

FIG. 4 is a face view of the interface of the wrist of FIG. 2;

FIG. 5 is a schematic view showing the wrist of FIG. 2 with an end effector and an end effector adaptor device of the present disclosure;

FIG. 6 is an assembly view of the wrist of FIG. 2 with a variant of the end effector adaptor device;

FIG. 7 is a first perspective view of a variant of the end effector adaptor device having a vision system in accordance with the present disclosure;

FIG. 8 is a second perspective view of the end effector adaptor device of FIG. 7;

FIG. 9 is an assembly view of an end effector adaptor device with a drill end effector, relative to the wrist of FIG. 2;

FIG. 10 is an assembly view of an end effector adaptor device with a gripper end effector, relative to the wrist of FIG. 2;

FIG. 11 is a perspective view of the end effector adaptor device and gripper end effector of FIG. 10;

FIG. 12 is an assembly view of an assembly of end effector adaptor devices with a pair of gripper end effectors;

FIG. 13 is a perspective view of another assembly of end effector adaptor devices with a pair of gripper end effectors;

FIG. 14 is a diagram showing an interchangeability of end effector adaptor devices and tools; and

FIG. 15 is a block diagram of a robot control system in accordance with the present disclosure.

### DETAILED DESCRIPTION

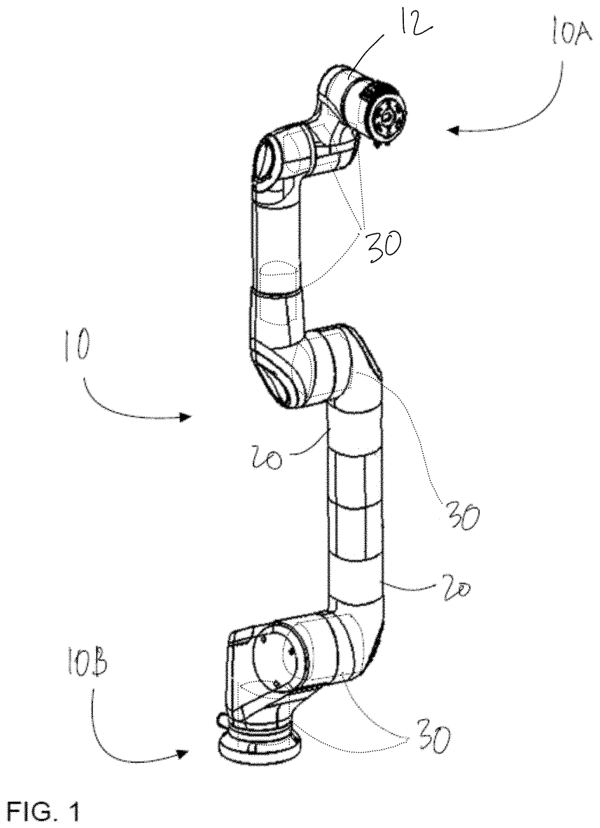

Referring to the drawings and more particularly to FIG. 1, a mechanism such as a robot arm in accordance with the present disclosure is generally shown at 10, and is also referred to as an articulated robotic arm or robotic arm, etc. Although a system for teaching a robot described herein is shown on the robotic arm 10, it may be used with other mechanisms, such as articulated mechanisms or arms, serial mechanisms or arms, parallel mechanisms or arms, or like mechanisms or arms. However, for simplicity, the expression “robot arm” is used throughout, but in a non-limiting manner. The robotic arm 10 is a serial articulated robot arm, having a working end 10A, i.e., the end at which an end effector is connected, and a base end 10B. The working end 10A is configured to receive any appropriate tool, such as gripping mechanism or gripper, anthropomorphic hand, tooling heads such as screwdrivers, drills, saws, an instrument drive mechanism, camera or other sensor system, etc. The end effector secured to the working end 10A is as a function of the contemplated use. End effector adaptor devices in accordance with the present disclosure are releasably connected to the working end 10A in a manner described below.

The base end 10B is configured to be connected to any appropriate structure or mechanism. The base end 10B may be rotatably mounted or not to the structure or mechanism. By way of a non-exhaustive example, the base end 10B may be mounted to a wheelchair, to a vehicle, to a frame, to a cart, to a robot docking station. Although a serial robot arm is shown, the joint arrangement of the robotic arm 10 may be found in other types of robots, including parallel manipulators.

Still referring to FIG. 1, a wrist 12 is shown at the working end 10A of the robotic arm 10. The wrist 12 is one of a series of links of the robotic arm 10. The wrist 12 may be referred to as a wrist link, a distal link, etc, and may even be referred to as end effector. The wrist 12 may be connected to a remainder of the robotic arm 10 by a motorized joint unit as described below.

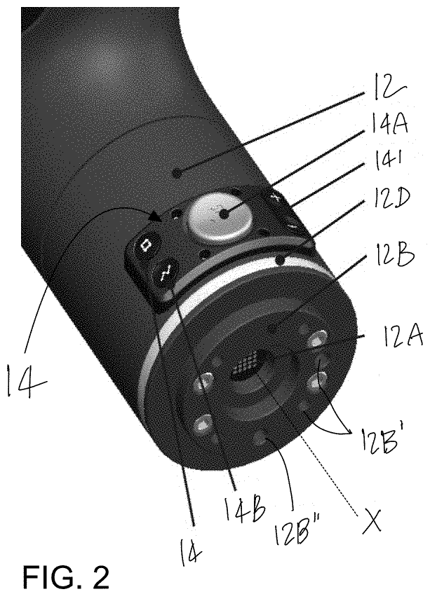

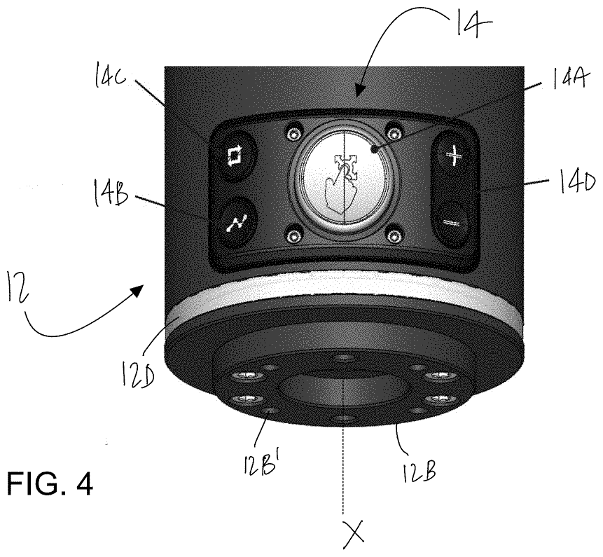

Referring concurrently to FIGS. 2 to 4, the wrist 12 may have numerous exposed components to allow connection of an end effector, and to enable a user to communicate with a control system associated with the robotic arm 10. In an embodiment, the wrist 12 rotates about axis X, and may be movable in numerous degrees of freedom enabled by the robotic arm 10.

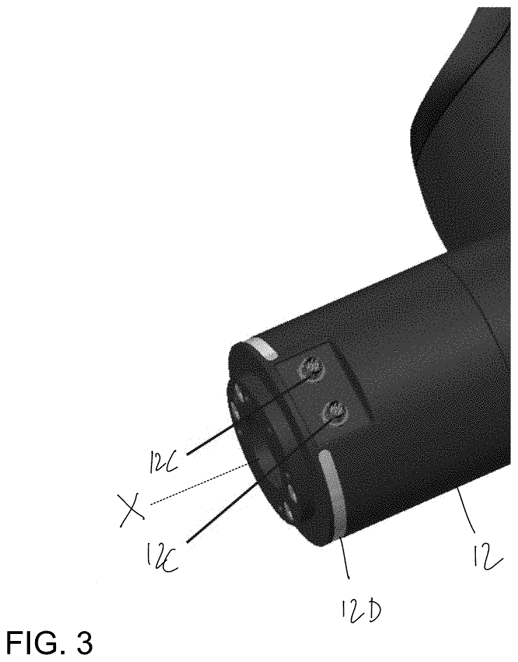

Among possible components present at the wrist 12, a connector 12A may be provided. The connector 12A may be a pogo-pin type socket by which a tool may be connected to a control system of the robotic arm 10. Other types of sockets, plugs, connectors may be used, the pogo-pin type socket being merely provided as an example. For instance, the connector 12A provides Ethernet connection, or may comply with the RS-485 standard or others (ModBUS, CANopen standards), and/or may have any appropriate power output (e.g., 24V, 4 A+). A flange 12B may surround the connector 12A may be provided with attachment bores 12B′ or other female or male attachments. An end effector, tool, peripheral with complementary attachments could hence be fixed to the wrist 12, the end effector, tool, peripheral also having a complementary connector for electronic engagement with the connector 12A. Referring to FIG. 3, additional connectors may be provided, such as peripheral connectors shown as 12C. As exemplary connectors 12C, M8 8-pin connectors are shown. Though not shown, sealed caps or plugs may be releasably installed on the connectors 12A and 12C to provide ingress protection.

A light display 12D may optionally be provided. In an embodiment, the light display 12D extends peripherally around the wrist 12, to provide visibility from an enhanced point of view. For example, the light display 12D may cover at least 180 degrees of the circumference of the wrist 12. In the illustrated embodiment, the light display covers between 280 and 320 degrees of the circumference of the wrist 12. The light display 12D may be considered a user interface as it may provide information to the operator, such as a flashing or color indication when certain teaching tasks are performed. The light display 12D may take other forms or configurations. For example, discrete lights may be present in addition to or as alternatives to the light display 12D. In an embodiment, the various lights are light-emitting diodes (LEDs), though other types of light sources may be used. The LEDs, such as those in the light display 12D, may be RGD LEDs.

An interface 14 may also be present on the wrist 12, and may include buttons, an additional port, etc. An exemplary combination of buttons for the interface 14 are provided, but any other arrangement than that shown and described is possible. The interface 14 may include a direction button(s) 14A to enable a manual control of directional movements of the wrist 12. By pressing on the direction button 14A, a user may manipulate the robotic arm 10. Accordingly, the pressing of the direction button 14A may cause a release of any brake or of selected brake(s) at the various joints of the robotic arm 10, such that the user may displace the end effector at the end of the wrist 12 and/or move the links at opposite sides of any of the joints. In a variant, the user may be required to maintain a pressure on the direction button 14A for the manual control to be activated. Practically speaking, the user may use one hand to press on the direction button 14A, and the other hand may be free to manipulate other parts of the robotic arm 10, to press on other buttons to record a condition of the robotic arm 10, and/or to use an interface associated with a controller of the robotic arm 10. The direction button 14A may also be used as an on/off switch for the manual control mode, whereby a single press on the direction button 14A may allow a user to toggle between an activation and deactivation of the manual control mode. Alternatively, the direction button 14A could have a sensitive periphery, with the robotic arm 10 responding to a press of the direction button 14A to move in the pressed direction. Instead of a single direction button 14A, multiple buttons may be present.

Other buttons may be present, such as single-function buttons 14B and 14C. For example, button 14B may be a position capture button (a.k.a., waypoint capture button), whereas button 14C may be a mode toggling button, as will be explained below. There may be fewer or more of the single-function buttons 14B and 14C, and such buttons may be associated with any given function. A 2-position level button 14D may be present, to select (e.g., increase or decrease) a level of intensity, as observed from the +/−symbols. The 2-position level button 14D may be known as a volume button, or intensity button, for instance to adjust levels associated with the programming of a function (e.g., gripper speed). The buttons 14A, 14B and 14C are shown as being mechanical buttons, in that a mechanical force must be applied to trigger electronic components. In an embodiment, the button 14A differs in shape from the buttons 14B,14C, and from the button 14D, to provide a user with a visual distinction between buttons and hence make the use of the interface 14 more intuitive. In an embodiment, the interface 14 may comply with the standard ANSI/UL 508, as the interface 14 operating the robot arm 10 is an industrial control device, for starting, stopping, regulating, controlling, or protecting electric motors, described below for example as being part of the motorization units 30.

Other types of wrist interfaces are contemplated. For example, a touchscreen may be used instead of the mechanical buttons, to provide similar functions, or additional ones, and provide display capacity as well. The touchscreen could thus be used as an alternative to both the light display 12D and to the buttons 14A-14C.

In addition to the wrist 12 at its working end 10A, the robotic arm 10 has a series of links 20, interconnected by motorized joint units 30, at the junction between adjacent links 20, forming joints between the links 20, the joints being for example rotational joints (a.k.a., one rotational degree-of-freedom (DOF) joints). The motorized joint units 30 may integrate brakes. For example, the integrated brakes may be normally open brakes that block the robotic arm 10 from moving when the robotic arm 10 is not powered. However, the brakes in the motorized joint units, or at least some of the brakes in the motorized joint units 30, may be normally open brakes. Moreover, the robotic arm 10 may rely on internal friction and/or inertia to hold a relative orientation between links 20, when the robotic arm 10 is not powered. A bottom one of the links 20 is shown and referred to herein as a robot arm base link 20′, or simply base link 20′, and may or may not be releasably connected to a docking cradle.

The links 20, including the wrist 12, define the majority of the outer surface of the robotic arm 10. The links 20 also have a structural function in that they form the skeleton of the robotic arm 10 (i.e., an outer shell skeleton), by supporting the motorized joint units 30 and tools at the working end 10A, with loads supported by the tools, in addition to supporting the weight of the robotic arm 10 itself. Electronic components may be concealed into the links 20. The arrangement of links 12,20 provides the various degrees of freedom (DOF) of movement of the working end 10A of the robotic arm 10. In an embodiment, there are sufficient links 12,20 to enable six DOFs of movement (i.e., three rotations and three translations) to the working end 10A, relative to the base link 20′. There may be fewer DOFs depending on the use of the robotic arm 10.

The motorized joint units 30 interconnect adjacent links 20, in such a way that a rotational degree of actuation is provided between adjacent links 20. According to an embodiment, the motorized joint units 30 may also connect a link to a tool via the wrist 12 at the working end 10A, although other mechanisms may be used at the working end 10A and at the base end 10B. The wrist 12 may be straight in shape, in contrast to some other ones of the links 20 being elbow shaped. The motorized joint units 30 may also form part of a structure of the robotic arm 10, as they interconnect adjacent links 20. The motorized joint units 30 form a drive system 30′ (FIG. 15) of the robotic arm 10 as they are tasked with driving the end effector connected to the robotic arm 10, for instance in accordance with a robotic application or commands, or through user commands. While they are schematically shown, the motorized joint units 30 may include motors, gearboxes, brake(s), drive electronics, among other things, to actuate movements of the robotic arm 10.

A communications link may extend through the robotic arm 10. In an embodiment, each link 20 includes signal transmission means (e.g., wires, cables, PCB, plugs and sockets, slip rings, etc), with the signal transmission means being serially connected from the base end 10B to the working end 10A, such that an end effector and a base controller may be communicatively coupled. The communications link may also be via a wireless communications link. The communications link may be accessible via the connector 12A, and the connectors 12C, and may be internally routed.

For example, the communications link in the robotic arm 10 may enable the transmission of Ethernet signals, USB signals, Ethercat signals, via one or multiple high speed data buses, at the wrist 12. Transmissions speeds may be of 10 mbit/sec or more as a possibility. In an embodiment, the signal transmission device 40 is designed to handle multiple ethernet or other communication buses (e.g., one or more) at speeds of 100 mBit, 1 Gbit or faster, in a compact, highly integrated form directly in the links 20 (e.g., Ethercat, USB Superspeed, etc.).

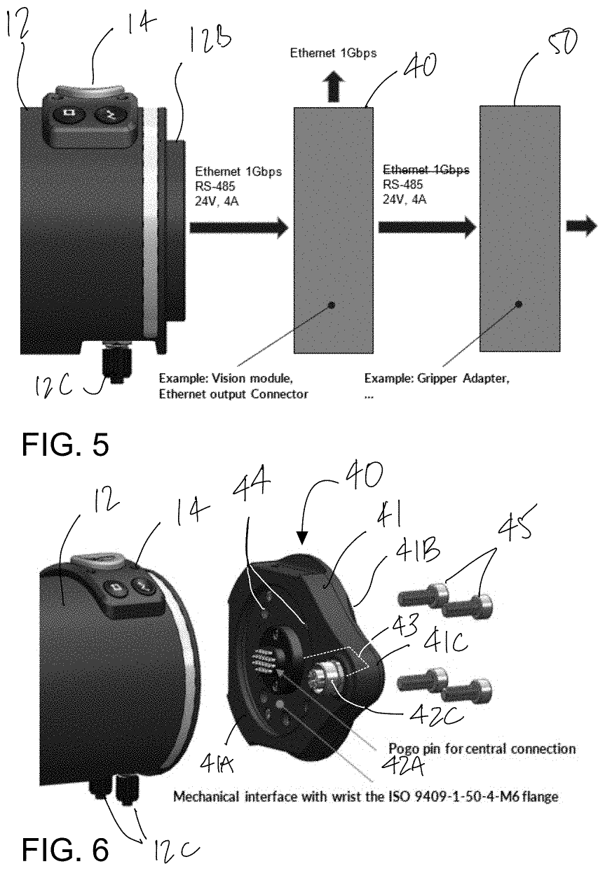

Referring to FIG. 5, the wrist 12 is shown relative to an end effector adaptor device 40 of the present disclosure, and an end effector 50. The end effector adaptor device 40 interfaces the end effector 50 to the robotic arm 10, via the wrist 12. While the expression “adaptor device” is used, device 40 could be known as an interface device, as it serves to interface an end effector 50 to the wrist 12 or other part of the robotic arm 10. Accordingly, by connection to the robotic arm 10 via the end effector adaptor device 40, the end effector 50 is operational and may be controlled by a controller system of the robotic arm 10, to perform its functions. Stated differently, the end effector 50 becomes part of the robotic arm 10. The communications link extends through the end effector adaptor device 40, though with the possibility of using some bandwidth of the communications links, such as by channels, or buses for functionalities to be operated by the end effector adaptor device 40. For example, as illustrated, the wrist 12 may have Ethernet capacity, along with RS-485 drive signal capacity (e.g., 24V, 4 A). The end effector 50 may be driven by the RS-485 signal, while the end effector adaptor device 40 uses the Ethernet channel, for instance by having an output connector or an apparatus such as a vision system.

Referring to FIG. 6, an embodiment of the end effector adaptor device 40 is shown. The end effector adaptor device 40 has a body 41. The body 41 may be act as a spacer. The body 41 has a proximal face 41A and a distal face 41B. A lateral extension 41C may project laterally from the body 41. The proximal face 41A is configured to be complementary in shape with the distal end of the wrist 12. For example, the proximal face 41A is shown having an annular channel, sized to matingly receive with flange 12B of the wrist 12. This is merely an example of a shape, as other shapes may be defined depending on the geometry of the wrist 12. In an embodiment, as shown planes of the faces 41A and 41B may be parallel to one another, though other examples given herein show a different arrangement.

As the end effector adaptor device 40 is tasked with powering an end effector 50 (FIG. 5), a proximal connector 42A is present on the proximal face 41A, and another connector, a distal connector (e.g., 42B, FIG. 6) is on the distal face 41B. The connector 42A is complementary to the connector 12A of the wrist 12 (FIG. 2). Therefore, as shown the connector 42A may be a pogo-pin type plug, at the end of a mount, for mating penetration in the socket of the connector 12A. Other arrangements are possible, depending on the type of connector that is at the end of the wrist 12. The connector 42B on the distal face 41B may be of any appropriate type, and may be selected as a function of the type of end effector 50 that is to be mounted to the wrist 12 via the end effector adaptor device 40. For example, the connector 42B has capacity to transmit signal in the RS-485 standard, for control of the end effector 50. In an embodiment, there may be a set of end effector adaptor devices 40 having the configuration shown in FIG. 6, but with different configurations to the distal face 41B, specific to end effectors 50.

Optionally, another connector 42C may be present, and may be on the lateral extension 41C. For example, the connector 42C may be used for Ethernet communication, for a peripheral to communicate with the robotic arm 10. Consequently, the connector 42C may be an M12 connector, as an example among others. Accordingly, the communications link of the robotic arm 10, offering different communication capabilities at the wrist 12, may be diverted into two (or more) separate outputs by the end effector adaptor device 40, namely the connector 42B and the connector 42C. Signal transmission circuitry 43 (e.g., wires, PCB, etc) may be within the body 41 for the connection of the connectors 42A, 42B and 42C (if present). The signal transmission circuitry 43 may include the necessary components for signal transmission, e.g., an Ethernet router for example. Though not shown, sealed caps or plugs may be releasably installed on the connectors 42A, 42B and/or 42C to provide ingress protection to the end effector adaptor device 40.

In order to secure the end effector adaptor device 40 to the wrist 12, bores 44 may be defined in the body 41, to match a distribution of attachment means in the wrist 12, such as the attachment bores 12B′. Fasteners 45 may for example be used to secure the end effector adaptor device 40 to the wrist 12, in such a way that the end effector adaptor device 40 is electrically coupled to the wrist 12 via the connection of the connectors 12A and 42A. Likewise, the distal face 41B may have its own set of attachment features, for securing the end effector 50 to the end effector adaptor device 40, or for stacking another one of the end effector adaptor devices 40. These attachment features may be bores or like holes that may be threaded, threading, pins, projections, etc. The attachment features may be complementary to attachment features of the end effector 50. Moreover, while the attachment features may be on the distal face 41B, they may also be on lateral surfaces of the body 41.

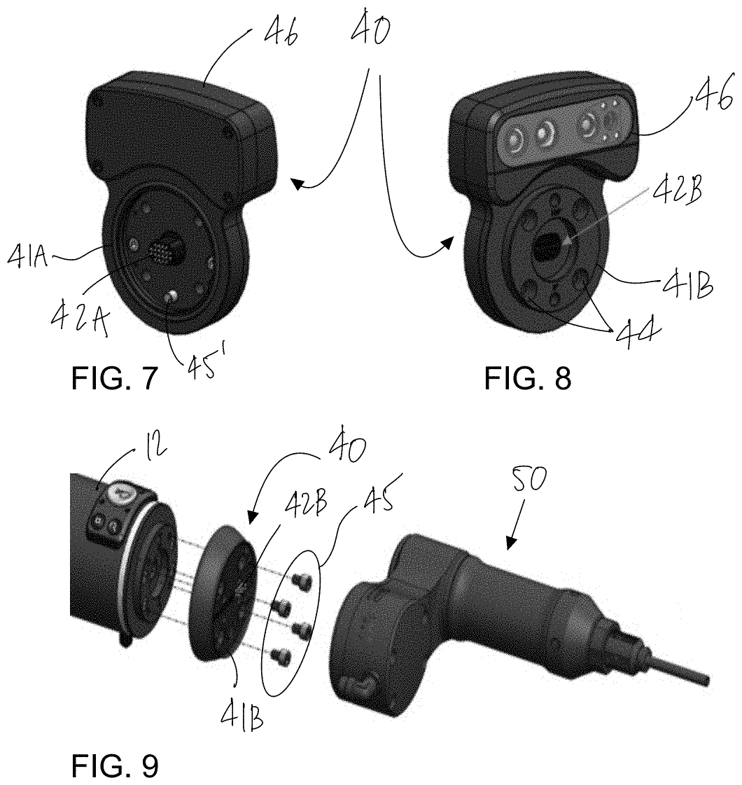

Referring to FIGS. 7 and 8, another variant of the end effector adaptor device 40 is shown. The end effector adaptor device 40 shares components with the end effector adaptor device 40 of FIG. 6, whereby like reference numerals will refer to like elements. However, instead of having a connector 42C in the lateral extension 41C, the end effector adaptor device 40 has a vision module 46. The vision module 46 may include one or more lenses or cameras (three shown), a light source or flash. For example, the vision module 46 may have different types of cameras having different characteristics and specifications, such as wide-angle or ultra-wide angle cameras. In a variant, the lens(es), camera(s), light source, flash are on the distal face of the lateral extension 41C, so as to face toward the end effector 50. The vision module 46 may use the Ethernet communication channel diverted from the wrist 12, which the connector 42B uses the RS-485 communication channel. As observed from FIG. 7, an alignment pin 45′ may be present in the proximal face 41A of the body 41 of the end effector adaptor device 40. The alignment pin 45′ my be received in a complementary bore 12B″ in the wrist 12. The alignment pin 45′ and complementary bore 12B″ may be used as a clocking feature to properly orient the end effector adaptor device 40 relative to the wrist 12, i.e., to have the vision module 46 located at a desired orientation instead of being 180 degrees off.

Referring to FIG. 9, an assembly view shows the end effector being a drill end effector 50 (e.g., for screwdriving as a possible function). The drill end effector 50 may be a third-party tool that is not configured for direct attachment to the wrist 12. Therefore, the end effector adaptor device 40 is used as interface between the drilling end effector 50 and the wrist 12, by having the connector 42B suited for operation of the drilling end effector 50, and connection features corresponding to those of the drilling end effector 50.

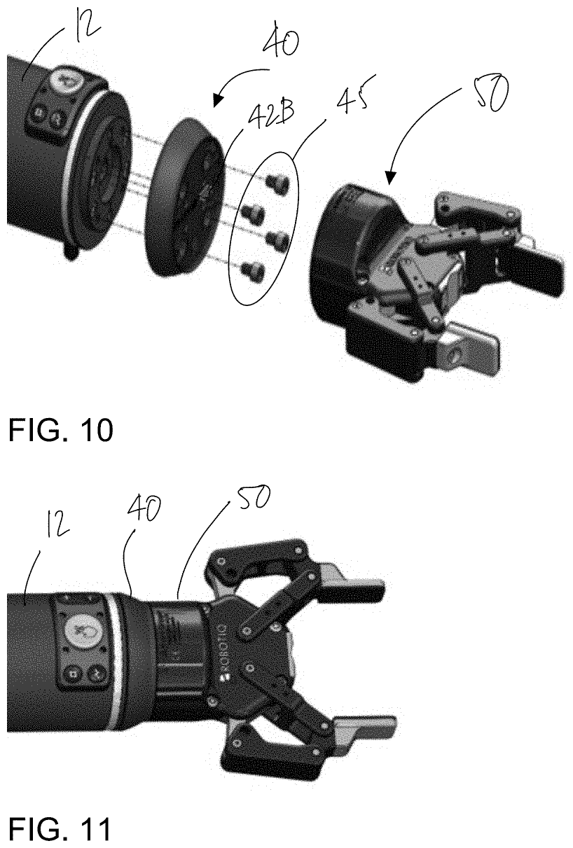

Likewise, referring to FIGS. 10 and 11, an assembly view shows the end effector being a gripper end effector 50. The gripper end effector 50 may also be a third-party tool that is not configured for direct attachment to the wrist 12. The end effector adaptor device 40 is used as interface between the gripper end effector 50 and the wrist 12, by having the connector 42B suited for operation of the gripping end effector 50, and connection features corresponding to those of the gripping end effector 50. The body 41 of the end effector adaptor device 40 in FIGS. 10 and 11 is shown tapering in a distal direction, to give a streamlined geometry to the assembly.

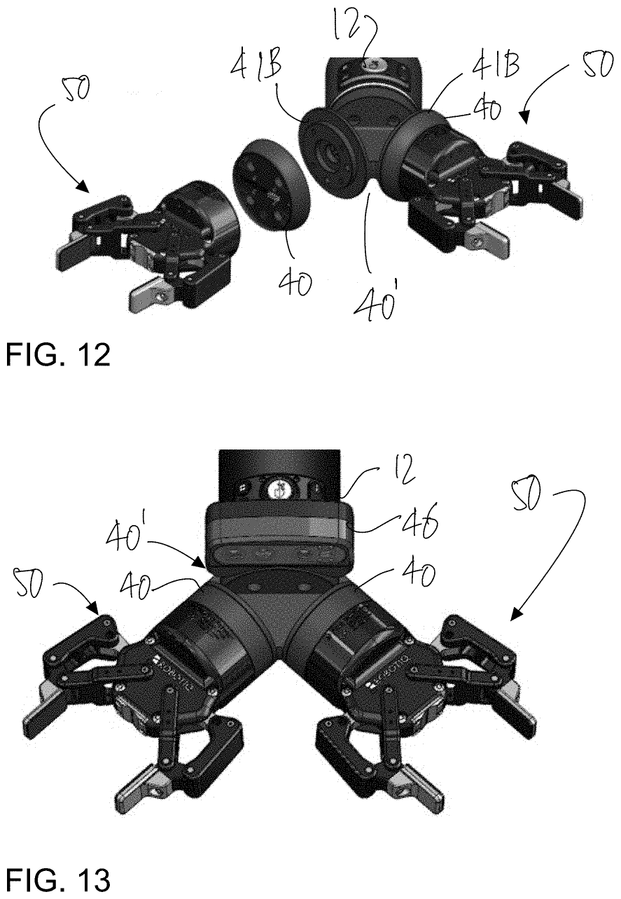

Referring to FIG. 12, the end effector adaptor device is shown 40′, and is a dual-tool end effector adaptor device. The end effector adaptor device 40′ has two of the distal faces 41B, branching out from the proximal face 41A. The body 41 is therefore tee-like or Y-shaped, with the distal faces 41B lying in planes that are at 45 degrees and 135 degrees of the plane of the proximal face 41A. Other orientations are possible, such as 90 degree angles for both distal faces 41B. Moreover, additional distal faces 41B may be provided. The end effector adaptor device 40′ may have end effectors 50 directly connected to its distal faces 41B. However, as shown, the end effector adaptor device 40′ may also be used with end effector adaptor devices 40 as described in FIGS. 10 and 11. In the illustrated embodiment, the distal faces 41B are a duplication of the end face of the wrist 12, whereby the end effector adaptor devices 40 as in FIGS. 10 and 11 may be required to adapt the end effector adaptor device 40′ to given third-party end effectors 50. The end effectors 50 in FIG. 12 are gripper end effectors, similar to that shown in FIGS. 10 and 11. It is possible to have two different types of end effectors 50 with the end effector adaptor device 40′, such as the drilling end effector 50 of FIG. 9 and the gripper end effector 50 of FIGS. 10 and 11.

Referring to FIG. 13, an assembly is shown featuring the end effector adaptor device 40′ with a pair of gripper end effectors 50 (or other types of end effectors 50), and with another end effector adaptor device 40 between the wrist 12 and the end effector adaptor device 40′. The other end effector adaptor device 40 may be as in FIGS. 7 and 8, and may have the vision module 46. The assembly of FIG. 13 would require sufficient bandwidth for the communications link to control both end effectors 50 (e.g., using RS-485 channels) and the vision module 46 of the end effector adaptor device 40 (e.g., Ethernet channel). As yet another possibility, the end effector adaptor device 40′ could be connected directly to the wrist 12 (as in FIG. 12), and an end effector adaptor device 40 with vision module 46 could be at one or both of the distal faces 41B of the end effector adaptor device 40′. Hence, the robotic arm 10 could be equipped with two vision modules 46 and two end effectors 50.

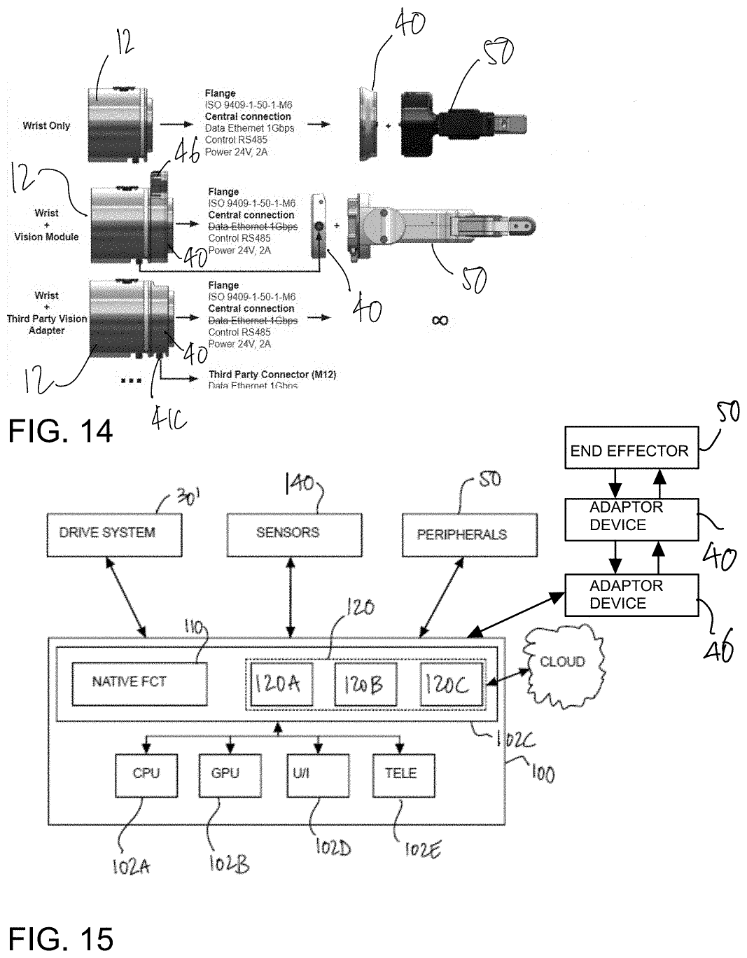

Referring to FIG. 14, the modularity of the end effector adaptor devices 40 is shown, with different end effector adaptor devices 40 used depending on the type of end effector 50. In the wrist only configuration, the gripper end effector 50 maintains all communication channels. When the vision module 46 is present, the Ethernet channel is used by the vision module 46, while the RS-485 is related to the operation of the end effector 50. The Ethernet channel may also be accessible via the connector 42 in the end effector adaptor device 40.

Referring to FIG. 15, a robot control system in accordance with the present disclosure is generally shown at 100. The robot control system 100 may be integrated into the robotic arm 10 (FIG. 1), such as in the base link 20′, in a docking station, in any other link, or as a separate unit, for instance in its casing. The robot control system 100 may include a processing unit. The processing unit may include all necessary components to operate the robotic arm 10, such as a central processing unit (CPU) 102A, graphics processing unit (GPU) 102B, a non-transitory computer-readable memory 102C, that may contain computer-readable program instructions executable by the processing unit for performing given functions associated with the robotic arm 10, including performing teaching tasks. The CPU 102A may include an operating system of the robotic arm 10, with or without using the non-transitory computer-readable memory 102C.

In addition to the interface 14 at the working end 10A of the robotic arm 10, additional interface or interfaces 102D may be part of the robot control system 100, or may be a peripheral of the robot control system 100, for a user to communicate with and receive data from the robot control system 100. The interface(s) 102D may be embedded or integrated in the robotic arm 10, or may be physically separated from the robotic arm 10. The interface(s) 102D may take numerous forms, such as a screen or monitor, a graphic user interface (GUI), a touch screen, visual indicators (e.g., LED), tablet, an application on a smart device (e.g., phone, tablet), keyboard, mouse, push buttons, etc. One of the interface(s) 102D may be used for controlling the robotic arm 10, and for teaching the robotic arm 10. Such a user interface 102D may be referred to as a teach pendant, a teach box, a remote controller, among other possible names. In an embodiment, the user interface 102D used as teach pendant may be wireless and may communicate with a remainder of the robot control system 100 of the robotic arm 10.

The robot control system 100 may further include telecommunications module 102E by which the robot control system 100 may communicate with external devices, systems. The telecommunications module 102E may have wireless and/or wired capability.

For example, the computer-readable program instructions may include native functions 110 of the robotic arm 10. The native functions 110 may include one or more of controllably moving the working end 10A in the available degrees of freedom of the robotic arm 10; holding a fixed position; performing a safety braking maneuver; permitting hand guiding and teaching; measuring the interaction forces on the robotic arm 10, among other native functions. The native functions 110 may be connected to the drive system 30′ for the control system 100 to drive the robotic arm 10 in a desired manner. The native functions 110 may also operate based on feedback provided by the sensors 40 within or associated to the robotic arm 10. The sensors 40 contribute to the high precision control of the robotic arm 10 in its working envelope.

Still referring to FIG. 15, the robot control system 100 may further include a container environment 120, for instance as hosted by the non-transitory computer-readable memory 102C, in the form of a virtual environment. The container environment 120 of the robot control system 100 is configured to receive one or more containers, exemplified as containers 120A, 120B, 120C, etc. The containers 120A-C may be programmed, uploaded, and/or transferred into container environment 120, by which applications related to the containers 120A-C may be run with the operating system of the robot control system 100, and have access to the various resources of the robot control system 100, such as CPU 102A, GPU 102B, interface(s) 102D, telecommunications module 102E, sensor data, native functions 110. Any one of the containers 120A-C may include its own independent operating system and dependencies, its entire run-time environment, with code, system tools, libraries and/or settings. Because of the container environment 120, the containers 120A-C may therefore be executed by the robot control system 100, in spite of their programming language. The containers 120A-C may be third-party customized, in third party libraries (e.g., Linux). The operating systems of the containers 120A-C, once installed, therefore produce signals that are used by the robot control system 100 to operate the robot arm 10 and/or peripherals. The operating systems of the containers 120A-C may also receive data from the robot control system 100 that may be indicative of the operation or state of the robot arm 10, as obtained by the sensor(s) 40.

In an embodiment, the container environment 120 is of plug-in nature, as they do not alter the operating system of the robot control system 100, and may not alter the native functions 110 (including safety functions), but instead may collaborate with the native functions 110 to have the robotic arm 10 perform desired tasks, associated with the containers 120A-C, by way of the operating systems of the containers 120A-C. The containers 120A-C may also be said to be isolated, as they may be executed without interfering with one another, or independently from one another. In an embodiment, the containers 120A-C employ the hardware of the robot arm 10, such as sensors 140, and may be used as a function of the end effector adaptor devices 40 and end effectors 50 mounted to the robotic arm 10. Indeed, the containers 120A-C are usable with peripherals that may be releasably connected to the robot arm 10, at the end effector for example or wired/connected to the robot control system 100 (e.g., as integrated into the robot arm 10 or as a separate component with its own housing).

Consequently, the container environment 120 may allow third parties to add functionality to the robot arm 10 via the access to the robot control system 100, for the use of third-party end effectors 50. The container environment 120 may not compromise performances of the robot arm 10 and safety features integrated to the operating system of the robot control system 100. The container environment 120 is a manager/host that may be tasked with dynamically limiting the performance of the plugin containers 120A-C in an optimized way, and may act as a firewall to separate the main, priority threads of the operating system from the functions of the containers 120A-C. The installation of a third-party plugin container(s) 120A-C may be assisted by installation widget or icon for a GUI of the interfaces 102D. For example, an installation procedure associated with containers 120A-C may include parameter set-ups for the functionalities of the containers 120A-C, and safety settings. The containers 120A-C may each include a container-specific GUI icon that may allow user activation of the application or functionality related to the container(s) 120A-C, as well as container-specific settings. It may be possible to adjust settings via a settings GUI that is part of the operating system of the robot control system 100. The container-specific GUI icon may integrate into the GUI environment of the interface 102D as operated by the robot control system 100. The plugin containers 120A-C may then have their own GUIs, once an application is activated or once a GUI icon is selected by a user. The plugin containers 120A-C may be written in a language that keeps the interface style the same as the main application/UI. In an embodiment, the settings and safeties associated with any of the containers 120A-C does not affect the settings and safeties of the operating system of the robot control system 100. For instance, safety settings of the robot control system 100 override the safety settings of any one of the plugin containers 120A-C.

Therefore, the container environment 120 could have numerous plugin containers, such as 120A-C. If required or desired, the plugin containers 120A-C may all be active at the same time—though a single one, two or more could be active at the same time as well. Moreover, the plugin containers 120A-C may be independent from one another. For example, one of the plugin containers 120A-C may be provided to control the gripper or other end effector, another one of the plugin containers 120A-C may be used to operator a vision system, another one of the plugin containers 120A-C may be tied to an application or contemplated use of the robot (e.g.: palletizing, bin picking, etc), another one of the plugin containers 120A-C may be for PLC communication, etc. The plugin containers 120A-C, may therefore operate concurrently as functions performed by the plugin containers 120A-C may be complementary, such as container for the gripper and another for the vision system. In addition, some plugin containers 120A-C may be active passively. For example, a plugin container 120A-C may be in a supervisory role, or handling non-realtime communication, or triggered only at a certain moment, whereas some may be timed/in-sync with the real-time robot control system 100 or in sync with an external trigger.

In an embodiment, the container environment 120 is configured for cloud communication. Therefore, one or more of the containers 120A-C may collaborate with cloud-based systems to enhance their functionalities. For example, a container 120A-C may collaborate with a cloud-based system or available processor or server to have access to higher computing power. The higher computing power may allow a container 120A-C to benefit from complex algorithms and/or to feed data to and from and receive commands from artificial intelligence systems.

In an embodiment, the container environment 120 may allow the use of various end effectors 50, such as add-on peripherals and extension, and replacement of control system hardware, such as GPU 102B and interfaces 102D, as a function of the containers 120A-C. As an example, the robot control system 100 is configured to facilitate the removal and upgrade of the GPU 102B, for instance to enable first-class (integrated) GPU-acceleration support, in order to facilitate improvements in computing power over time. The container environment 120 may dynamically benchmark and adjusts or throttle the available performance of each container application in line with available acceleration of the CPU and/or GPU 102B.

In terms of added functionalities, the container environment may support common AI frameworks, to enable functions such as for image/part detection, segmentation, localization directly in a visual programming tool, with the image or video feed from a vision module 46.

Numerous sensors 140 may be provided in the robotic arm 10, to automate a control of the robotic arm 10. The sensors 140 may include one or more of encoders, optical sensors, inertial sensors, force/torque sensors, infrared sensors, thermocouples, pressure sensors, proximity switches, etc.

The end effector adaptor devices 40 described herein may be said to be an EMI-safe way to couple end effectors 50 to a robotic arm such as the one shown at 10 in FIG. 1. This EMI compliance may be met whenever a metallic end effector is installed with appropriate (circumferential) metal-to-metal contact between the end effector 50 and the wrist 12, regardless of power supply/voltage (90 to 264 VAC), payload, accelerator, or power draw. The end effector adaptor devices 40 may be said to be modular and adaptable interfaces for tooling and sensors, with suitable power transmission capacity (e.g., at least 100 W) and communications bandwidth (e.g., gigabit level). By leveraging this adaptable architecture, any of the standard industrial controls (e.g., CANopen, RS485, etc) and sensing approaches (e.g., PoE, GigE Vision) are possible for OEM or 3rd party end effectors 50.

The end effector adaptor devices 40 may further be described as being modular puck devices that enable multiple high speed and high power end effector tools or sensors to be attached to the end of the robotic arm 10 without impacting the ingress protection or EMI performance of the arm 10. The end effector adaptor devices 40 may have standard mechanical interfaces (ISO 9409-1-50-1-M6) as well as a specific, reversible connectors (0 and 180 degree alignment), such as pogo pin electrical interface for both power and Ethernet. The end effector adaptor devices 40 may be used as stacked, for example to introduce a vision module 46, a connector 42C, and/or to adapt given end effectors 50 to the assembly. When stacked to add functionalities as described above, the end effector adaptor devices 40 may all have the same faces 41A and 41B (i.e., with flange and holes). The distal most end effector adaptor device 40 may have a different distal face 41B than the other end effector adaptor devices 40 of a stack, depending on the nature of the end effector 50 used.

1. An end effector adaptor device for a robotic arm comprising:
a body adapted to be secured to a working end of a robotic arm at a proximal face, the body having a distal face configured for connection of an end effector thereto,
a proximal connector in the proximal face, the proximal connector configured to be connected to a complementary connector at the working end of the robotic arm for signal and power transmission between the robotic arm and the body,
a distal connector in the distal face, the distal connector configured to be connected to a complementary connector at the end effector connected to the distal face for signal transmission and/or power transmission between the body and the end effector, and
circuitry between the proximal connector and the distal connector.

2. The end effector adaptor device according to claim 1, further including another connector between the proximal face and the distal face, the other connector connected to the proximal connector by the circuitry so as to be configured for signal and power transmission to another peripheral.

3. The end effector adaptor device according to claim 2, wherein the circuitry includes signal transmission circuitry configured to define a communication channel between the proximal connector, the distal connector and the other connector.

4. The end effector adaptor device according to claim 1, wherein the communication channel is an Ethernet communication channel.

5. The end effector adaptor device according to claim 1, further including a vision module on the body, the vision module being connected to the proximal connector by the circuitry so as to be configured for signal and power transmission with the robotic arm.

6. The end effector adaptor device according to claim 5, wherein the body has a lateral extension projecting laterally between the proximal face and the distal face of the body.

7. The end effector adaptor device according to claim 6, wherein the vision module has at least one lens on a distal face of the lateral extension.

8. The end effector adaptor device according to claim 1, wherein the body has a lateral extension projecting laterally between the proximal face and the distal face, with a communication port on the lateral extension, the communication port connected to the circuitry.

9. The end effector adaptor device according to claim 1, further comprising fasteners configured for releasably connecting the body to the robotic arm.

10. The end effector adaptor device according to claim 9, wherein the fasteners are accessible on the distal face of the body.

11. The end effector adaptor device according to claim 1, further comprising an alignment pin or bore in the proximal face of the body configured for engagement with a complementary component of the robotic arm.

12. The end effector adaptor device according to claim 1, wherein the body has two of the distal face, with each of the two distal faces configured to support an end effector.

13. The end effector adaptor device according to claim 12, wherein planes of the two distal faces of the adaptor device are angle relative to the proximal face.

14. The end effector adaptor device according to claim 12, wherein the body is tee-shaped or Y-shaped.

15. The end effector adaptor device according to claim 1, wherein the circuitry is a PCB embedded in the body.

16. The end effector adaptor device according to claim 15, wherein the PCB defines an EMI shield.

17. The end effector adaptor device according to claim 5, wherein the vision module includes a depth sensor.

18. The end effector adaptor device according to claim 1, wherein the body includes a force sensor and/or a torque sensor.

19. The end effector adaptor device according to claim 1, wherein the body a serial communication port or pogo pins.

20. An assembly comprising:
a robotic arm; and
an end effector adaptor device according to claim 1, the end effector adaptor device connected to an end of the robotic arm and configured to be connected to an end effector.
